(19) United States
(12) Patent Application Publication
(10) Pub. No.: US 2018/0024795 A1
(43) Pub. Date: Jan. 25, 2018

(54) PRINTING SYSTEM

(71) Applicants: KABUSHIKI KAISHA TOSHIBA, Tokyo (JP); TOSHIBA TEC KABUSHIKI KAISHA, Tokyo (JP)

(72) Inventor: Shungo Miyata, Numazu Shizuoka (JP)

(21) Appl. No.: 15/467,124

(22) Filed: Mar. 23, 2017

(30) Foreign Application Priority Data
Jul. 20, 2016 (JP) 2016-142317

(51) Int. Cl. G06F 3/12; H04N 1/00

(52) U.S. Cl. CPC G06F 3/1289; H04N 1/00411; G06F 3/1222; G06F 3/1203; G06F 3/1211; G06F 3/1236; G06F 3/1268; H04N 1/00244; H04N 2201/0094

(57) ABSTRACT

A printing system, which has a plurality of image forming apparatuses connected to a network and executes a print job with one image forming apparatus among the plurality of the image forming apparatuses, comprises a first image forming apparatus, a job sending section and a second image forming apparatus. The first image forming apparatus cannot carry out a first print job due to setting parameters of the first print job. The job sending section sends the first print job to an image forming apparatus designated via an operation section of the first image forming apparatus. The second image forming apparatus which is the designated image forming apparatus executes the first print job received from the job sending section without receiving an instruction of job execution via its own operation section.

### CROSS-REFERENCE TO RELATED APPLICATIONS

This application is based upon and claims the benefit of priority from Japanese Patent Application No. 2016-142317, filed Jul. 20, 2016, the entire contents of which are incorporated herein by reference.

### FIELD

Embodiments described herein relate generally to distributing print jobs to a plurality of image forming apparatuses.

### BACKGROUND

There is a system for distributing print jobs to a plurality of image forming apparatuses. In the system, after a user inputs a print job using a PC (personal computer) for work, a server receives the print job. The user faces a desired image forming apparatus to select the input print job from a displayed print job list. In response to the operation, the server sends the print job to the image forming apparatus, and the image forming apparatus starts printing. The printing can be carried out by the image forming apparatus desired by the user through a series of operations.

### DESCRIPTION OF THE DRAWINGS

FIG. 1 is a diagram illustrating an example of the entire constitution of a printing system according to an embodiment;

FIG. 2 is a schematic diagram illustrating an example of the inner constitution of an image forming apparatus according to the embodiment;

FIG. 3 is a block diagram illustrating an example of the constitution of the image forming apparatus shown in FIG. 2;

FIG. 4 is a block diagram illustrating an example of the constitution of a PC;

FIG. 5 is a block diagram illustrating an example of the constitution of a server;

FIG. 6 is a diagram illustrating a correspondence between a user and an image forming apparatus that can be used by the user and a correspondence between a function and an image forming apparatus capable of carrying out the function, which are held in the server;

FIG. 7 is a diagram illustrating an example of a screen at the time an arrangement diagram is uploaded;

FIG. 8 is a diagram illustrating an example of a printer driver screen displayed by the PC at the time a print job is input;

FIG. 9 is a diagram illustrating an example of a list of print jobs received by the server;

FIG. 10 is a diagram illustrating an example of a selection screen of print jobs displayed by the image forming apparatus;

FIG. 11 is a diagram illustrating an example of a screen, displayed by the image forming apparatus, which is used to select an execution destination of the print job;

FIG. 12 is a diagram illustrating an example of a screen, displayed by the image forming apparatus, which is used to select an arrangement diagram and an execution destination of the print job;

FIG. 13 is a diagram illustrating an example of operations of the server at the time of receiving a display request of an executable image forming apparatus from the PC;

FIG. 14 is a diagram illustrating an example of operations of the server at the time of receiving a print job from the PC;

FIG. 15 is a diagram illustrating an example of operations of the server at the time of receiving a request telegram from the image forming apparatus; and

FIG. 16 is a diagram illustrating an example of operations of the image forming apparatus.

### DETAILED DESCRIPTION

In accordance with an embodiment, a printing system, which has a plurality of image forming apparatuses connected to a network and executes a print job with one image forming apparatus among the plurality of the image forming apparatuses, comprises a first image forming apparatus, a job sending section and a second image forming apparatus. The first image forming apparatus cannot carry out a first print job due to setting parameters of the first print job. The job sending section sends the first print job to an image forming apparatus designated via an operation section of the first image forming apparatus. The second image forming apparatus which is the designated image forming apparatus executes the first print job received from the job sending section without receiving an instruction of job execution via its own operation section.

An image forming apparatus according to the embodiment displays identification information (names and the like) of image forming apparatuses that can execute a job as a list on an operation panel in a case in which the image forming apparatus cannot execute the job. Further, the image forming apparatus displays an arrangement diagram as well as the list so that a setting location of each of the image forming apparatuses is easily known.

The image forming apparatus according to the embodiment requests a server to carry out delivery of a print job so that a selected image forming apparatus becomes a delivery destination if one image forming apparatus is selected from the list displayed on the operation panel. The server sends the print job to the designated image forming apparatus, and the image forming apparatus that receives the print job starts printing.

Further, in the embodiment, the plurality of the image forming apparatuses is used; however, part or all of the image forming apparatuses can carry out both of printing with a decolorable color material and printing with a non-decolorable color material. The decolorable color material is fixed on a sheet at a temperature equal to or greater than a specified fixing temperature and is decolored if heated at a temperature equal to or greater than a specified decoloring temperature which is equal to or greater than the fixing temperature. The decolorable color material contains a color generation compound, a developer and a decoloring agent. As the color generation compound, for example, leuco dyes are exemplified. As the developer, for example, phenols are exemplified. As the decoloring agent, a substance which is blended with the color generation compound if heated and does not have affinity to the developer is exemplified. The decolorable color material develops the color through interaction of the color generation compound and the developer, and can be decolored as the interaction of the color generation compound and the developer is cut off through the heating at a temperature equal to or higher than the decoloring temperature.

In the embodiment, toner is exemplified as the color material; however, the form of the embodiment is also applied to a case in which an image forming processing is carried out using ink. The “decoloring” according to the embodiment refers to a processing of making an image formed with a color (containing not only chromatic colors but also achromatic colors such as white, black and the like) different from a base color of the sheet invisible visually. The “invisible visually” may be a state where the image formed with the color different from the base color of the sheet is changed to a color identical or similar to or with the base color of the sheet in addition to a form in which the image formed with the color different from the base color of the sheet is colorless (transparent).

Hereinafter, the present embodiment is described with reference to the accompanying drawings.

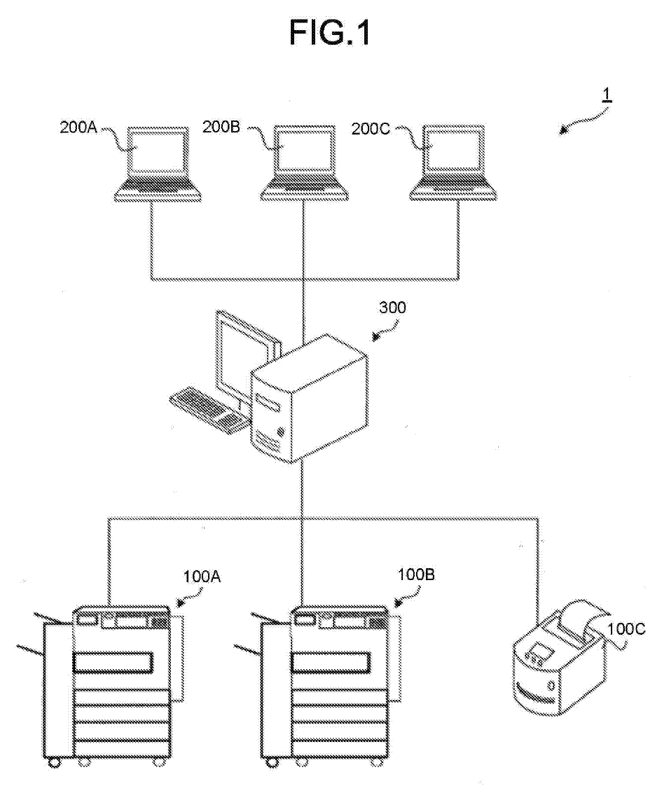

FIG. 1 is a diagram illustrating an example of the entire constitution of a printing system according to the embodiment. The printing system 1 includes a plurality of PCs 200A-200C, a server 300 (job delivery section) and a plurality of MFPs 100A-100C (MFP: Multifunction Peripheral) which are connected with each other so that they can mutually carryout transmission and reception of data. The PCs 200A-200C input print jobs of documents or images. In the present embodiment, there are three PCs; however, it is an example on earth. The server 300 receives a print job sent from each of the PCs. The server 300 temporarily accumulates one or a plurality of print jobs input from the PCs 200A-200C in order to collectively manage the print jobs. Further, the server 300 receives sending requests of the print jobs from the MFPs 100A-100C, and sends corresponding print jobs if the MFPs 100A-100C serving as request sources can carry out printing. In FIG. 1, there is one server 300; however, there may be a plurality of servers 300 in order to achieve load balancing and redundancy.

Executable functions of the MFPs 100A-100C serving as image forming apparatuses are different from each other. In the present embodiment, the MFP 100A is an image forming apparatus which can most correspond to various setting contents. The MFP 100A is possible to carry out, for example, printing with decolorable toner, monochrome printing and full color printing, and also includes a function for attaching a watermark. The MFP 100B cannot carry out the printing with the decolorable toner but can carry out the monochrome printing and the full color printing, and is also possible to attach the watermark. The MFP 100C is possible to carry out only the monochrome printing; otherwise, the printing with the decolorable toner or the full color printing and the attachment of the watermark cannot be carried out. Besides this, there is also a difference such as print enable/disable in a specific sheet size or a difference such as print enable/disable according to a specific print resolution.

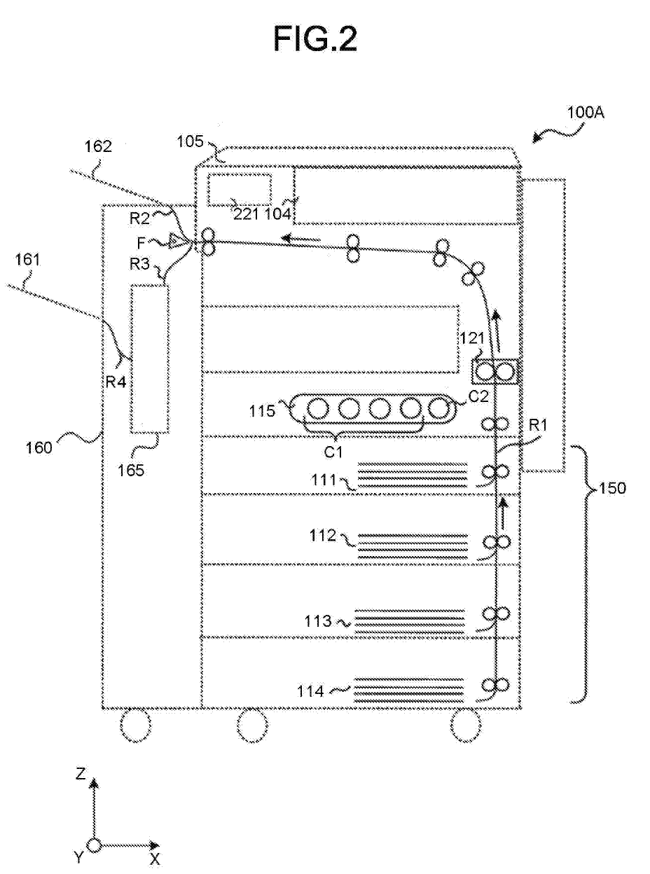

FIG. 2 is a schematic diagram illustrating an example of the inner constitution of the MFP 100A as an example of the MFP. Hereinafter, the constitution of the MFP 100A is described with reference to FIG. 2. Further, the inner constitution of the MFP 100A is mainly described herein; however, other MFPs 100B and 100C also have the same constitution as the MFP 100A.

The MFP 100A includes cassettes 111, 112, 113 and 114 which house sheets and supply the sheets at the time of job execution. The cassettes 111, 112, 113 and 114 respectively house unused new sheets of which sizes are different from each other. The cassette 112 houses used sheets which serve as objects of a decoloring processing. In the present embodiment, the decoloring processing refers to a heating processing on a sheet on which an image is formed with the decolorable color material at a temperature equal to or greater than a specified decoloring temperature. Further, the cassettes 111, 113 and 114 are referred to as normal cassettes, and the cassette 112 is referred to as a reuse cassette. The cassettes 111-114 are set as a sheet feed section 150.

The MFP 100A includes an image forming section 115 for forming an image on a sheet. The image forming section 115 can carry out both of the printing with the decolorable color material and the printing with the non-decolorable color material. The image forming section 115 includes a cartridge C1 for housing the non-decolorable color material serving as a normal color material and a cartridge C2 for housing the decolorable color material to be decolored at a temperature equal to or greater than a specified decoloring temperature. The cartridge C1 includes cartridges of all colors including cyan, magenta, yellow and black. Further, the MFP 100A includes a heating device 121 for heating and pressuring a sheet on which an image is formed to fix the image on the sheet. The heating device 121 decolors the image of the sheet housed in the reuse cassette 112 with the temperature thereof rising to the decoloring temperature (decoloring processing).

The MFP 100A includes a conveyance route R1 for conveying a sheet in the order of the sheet feed section 150, the image forming section 115, the heating device 121 and a post-processing apparatus 160 described later. Further, the MFP 100A includes an operation panel 104 for receiving an input of a parameter value such as the number of copies and an instruction of processing start from a user and displaying a state of progress of a job. The MFP 100A includes a scanner section 105 for reading a document sheet arranged on a transparent glass plate. An image read by the scanner section 105 is input to the image forming section 115, and the image forming section 115 forms the image on the sheet (copy processing).

The MFP 100A includes a card reader 221. The card reader 221 reads authentication information such as a user ID, a password and the like from an IC card owned by a user. The authentication information is used to determine presence/absence of use authority of the user to the MFP 100A. In a case in which the authentication information is adaptable, the user can use the MFP 100A, and in a case in which the authentication information is not adaptable, the user cannot use the MFP 100A. Further, restriction may be set for each function according to the authority of the user, for example, part of functions can be used and use of other functions is forbidden.

The MFP 100A includes the post-processing apparatus 160 that can be mounted optionally. The post-processing apparatus 160 carries out route switching with a flapper F to continuously convey the sheet conveyed via the conveyance route R1 in either a conveyance route R2 or a conveyance route R3. If the sheet is conveyed to the conveyance route R2, the sheet is output to a discharge tray 162 without any changes. On the other hand, if the sheet is conveyed to the conveyance route R3, a post-processing section 165 bundles sheets into a plurality of sheets to align the sheets and carries out a post-processing such as a stapling processing or a center folding processing. Further, a punching processing is carried out as the post-processing. The sheet or the sheet bundle to which the post-processing is carried out is output to a discharge tray 161 via the conveyance route R4.

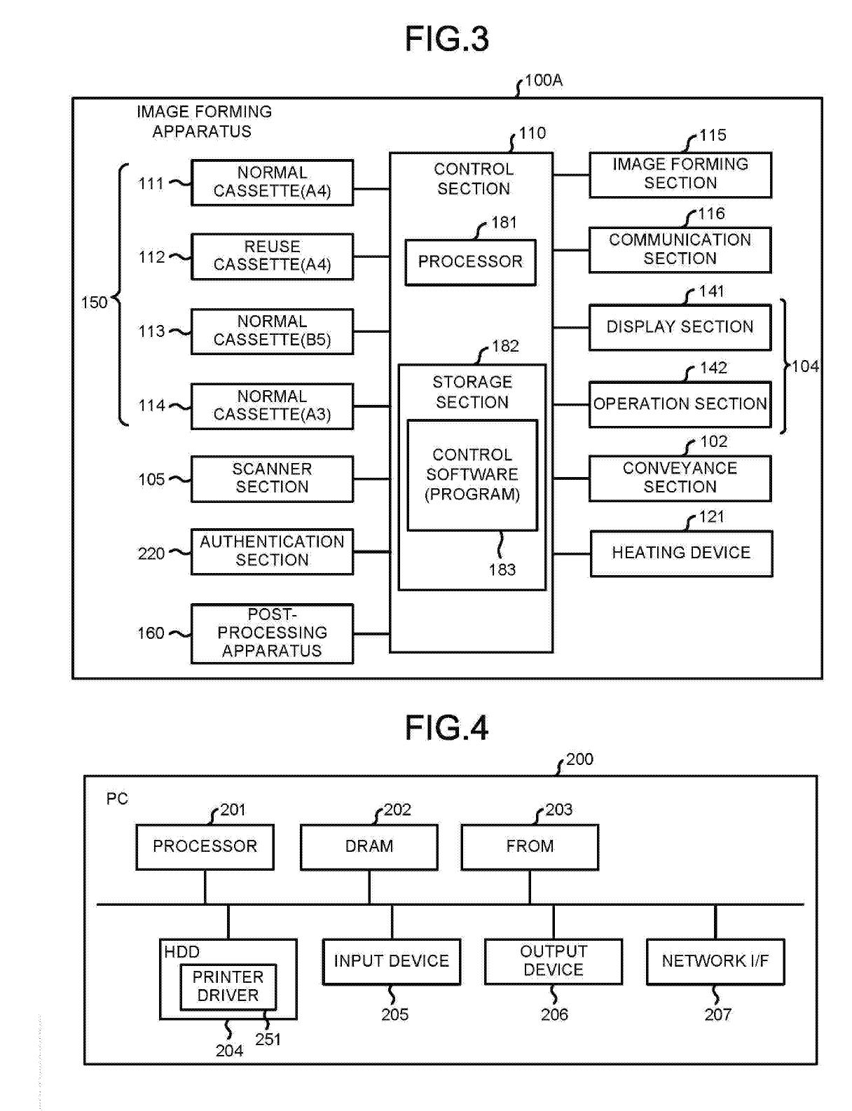

FIG. 3 is a block diagram illustrating an example of the constitution of the MFP 100A. The MFP 100A includes a control section 110 which at least includes a processor 181 and a storage section 182. The processor 181 is, for example, an arithmetic processing apparatus such as a CPU (Central Processing Unit). The processor 181 carries out programs stored in the storage section 182 to realize various functions. The storage section 182 is a unit including a main storage apparatus that stores data in a volatile manner and carries out input/output of direct data with the processor 181. Further, the storage section 182 is a unit including a ROM and an auxiliary storage apparatus and stores control software 183 (program) and data in a nonvolatile manner. The processor 181 executes the control software 183, and in this way, the control section 110 collectively controls a main body unit of the MFP 100A and provides functions described below. Further, part or all of the functions provided by the control section 110 may be implemented in a circuit such as ASIC (Application Specific Integrated Circuit).

The MFP 100A includes a communication section 116. The communication section 116 receives print data from the server 300 on the basis of an instruction of the control section 110. Further, the communication section 116 sends a message relating to a processing result or a status and various request telegrams to the server 300. The MFP 100A receives a print job, and then forms an image included in the print job on a sheet (print processing).

The operation panel 104 includes a display section 141 serving as a flat type liquid crystal monitor and an operation section 142 composed of physical buttons and a touch panel laminated on the display section 141. A conveyance section 102 which includes the conveyance route R1 conveys the sheet to each unit according to an instruction of the control section 110.

The normal cassettes 111, 113 and 114 shown in FIG. 3 and the reuse cassette 112 are stated above; however, the size of the sheet to be housed is described in brackets in FIG. 3. In the present embodiment, the normal cassette 111 and the reuse cassette 112 house sheets of A4 size. Further, the normal cassette 113 houses sheets of B5 size, and the normal cassette 114 houses sheets of A3 size. Further, the scanner section 105, the post-processing apparatus 160, the image forming section 115 and the heating device 121 are stated above.

An authentication section 220 includes the card reader 221 and carries out a login authentication of the user. All the operations in the user authentication processing may be carried out by the MFP 100A, and adaptation determination may be carried out by, for example, an external authentication server. In this case, the MFP 100A uses the card reader 221 to carry out the reading of the authentication information, and the authentication server carries out the adaptation determination. The MFP 100A receives a determination result from the authentication server to carry out control of execution permission/rejection of each function.

FIG. 4 is a block diagram illustrating an example of the constitution of the PC 200A. The PCs 200B and 200C also have the same constitution as the PC 200A. The PC 200A includes a processor 201 serving as an arithmetic processing apparatus and a DRAM 202 that directly carry out input/output of data with the processor 201 and stores the data in a volatile manner. The PC 200A includes a FROM 203 serving as a flash ROM that stores a system program in a nonvolatile manner. The PC 200A includes an HDD 204 (HDD: hard disk drive) that stores a program and data in a nonvolatile manner. A printer driver 251 for generating the print jobs of the MFPs 100A-100C is stored in the HDD 204.

Further, the PC 200A includes an input device 205 such as a keyboard or a mouse, an output device 206 such as a monitor or a liquid crystal display and a network I/F 207 (I/F: interface) for performing control of data communication with an external device.

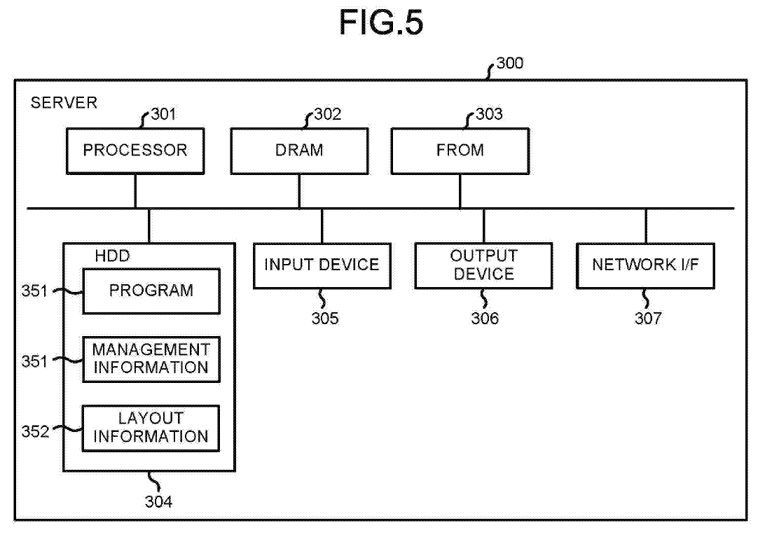

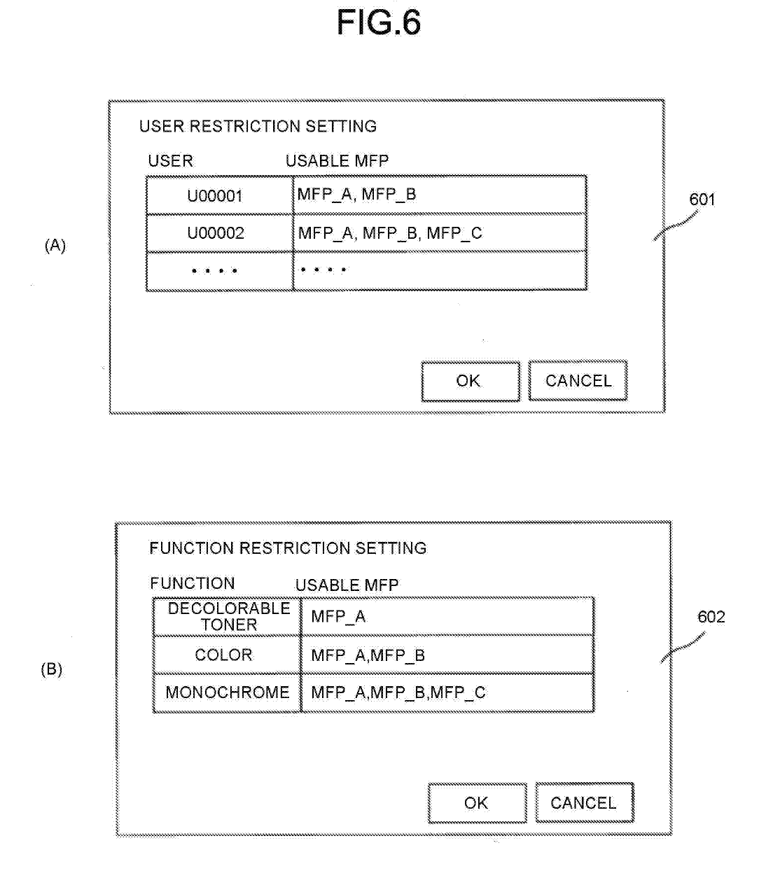

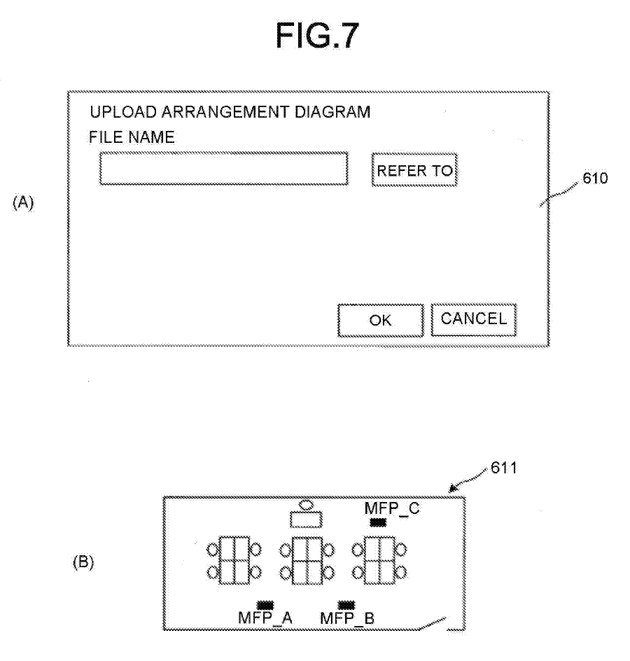

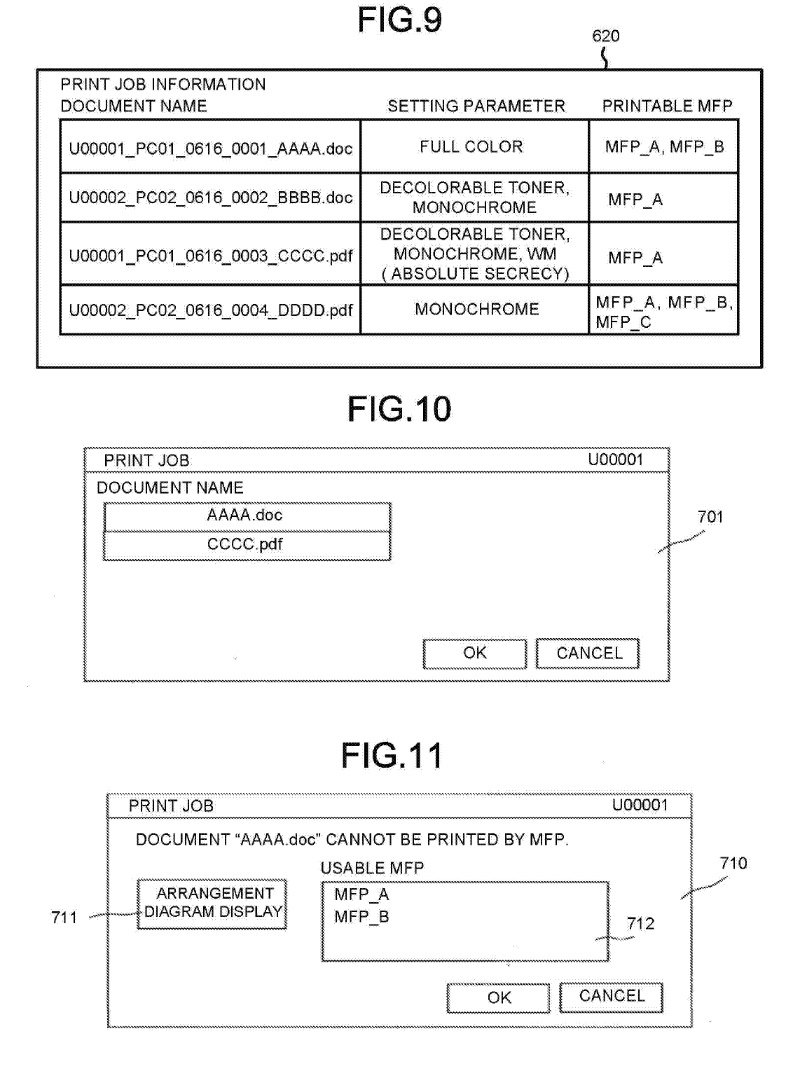

FIG. 5 is a block diagram illustrating an example of the constitution of the server 300. The server 300 includes a processor 301, a DRAM 302, a FROM 303, an HDD 304, an input device 305, an output device 306 and a network I/F 307. These units are the same as the units of the PC 200A shown in FIG. 4. In addition to a program 351, management information 351 (refer to FIG. 6 and FIG. 9 described later) of print jobs and layout information 352 (refer to FIG. 7 (B) described later) serving as an arrangement diagram of MFPs are stored in the HDD 304.

FIG. 6 illustrates part of the management information 351 stored in the server 300. The information shown in FIG. 6 is set by users who has manager authority for the server 300, and can be changed by the input device 305 and the output device 306 even in operation. In the following description (specifically, in drawings), there is a case in which the MFP 100A is denoted as an MFP_A, the MFP 100B is denoted as an MFP_B, and the MFP 100C is denoted as an MFP_C. FIG. 6 (A) is a diagram illustrating a correspondence between a user and an image forming apparatus that can be used by the user. In the present embodiment, a user of whom the ID is U00001 can use the MFP 100A and the MFP 100B, and is not allowed to use the MFP 100C. A user of whom the ID is U00002 can use all of the MFP 100A, the MFP 100B and the MFP 100C.

FIG. 6 (B) illustrates restriction in the functional aspect of each MFP. The printing with the decolorable toner can be carried out only by the MFP 100A, and other MFP 100B and MFP 100C cannot carry out the printing with the decolorable toner. The full color printing can be carried out only by the MFP 100A and the MFP 100B, and the monochrome printing can be carried out by all of the MFP 100A, the MFP 100B and the MFP 100C. In FIG. 6 (B), the restriction in terms of usable toner (decolorable toner/color toner/monochrome toner) is exemplified; however, restriction in execution availability of a watermark or a usable sheet size can also be set.

FIG. 7 (A) is a screen image for registering an image (arrangement diagram) for displaying an indoor location of an MFP. The output device 306 of the server 300 displays a registration screen 610 shown in FIG. 7 (A). The user creates, for example, an image 611 shown in FIG. 7 (B) in advance and registers the image 611 via the registration screen 610. In the present embodiment, a still image is registered; however, a Web based HTML file or a CSS file and a predetermined logic script file for dynamic change may be created and registered so that display contents are dynamically changed.

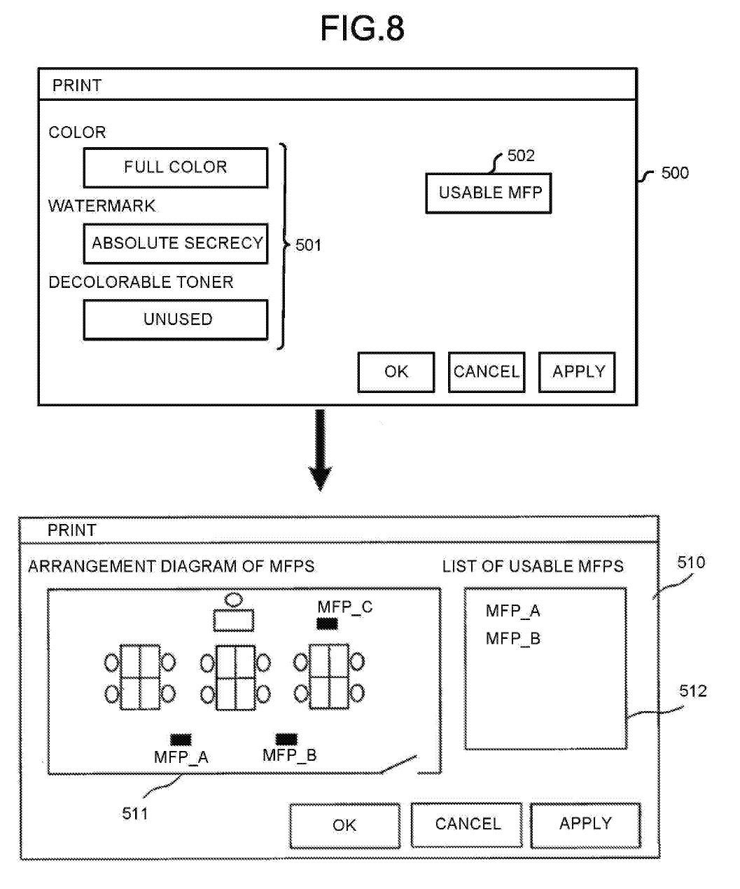

FIG. 8 is a screen image at the time a print job is input which is displayed when the processor 201 of the PC 200A carries out the printer driver 251. The PC 200A is described as an example herein; however, the PCs 200B and 200C can also display the same screen. The PC 200A carries out a predetermined operation to display a printing setting screen 500 on the output device 206 at the time an edited document or image is printed. The user inputs and sets a color, presence/absence of a watermark or a character string, and presence/absence of use of the decolorable toner for a parameter setting column 501, and in this way, setting parameters are assigned to a print job. If a button 502 in the printing setting screen 500 is pressed, the screen moves to a screen 501 shown at the lower stage. The output device 206 displays the image 611 (refer to FIG. 7 (B)) registered in advance as the arrangement diagram 511. Further, the output device 206 displays a list of MFPs that can carry out printing under the condition of the parameters set by the parameter setting column 501 as a list 512. The user selects one MFP from the list 512 to press an OK button, and in this way, a print job is sent to the MFP selected via the server 300. The user can face the MFP selected and designated by himself/herself with reference to the arrangement diagram 511 to get a print document.

On the other hand, in a case in which no MFP is selected particularly and the OK button is pressed, the print job is temporarily sent to the server 300.

FIG. 9 is a diagram in which the contents of the print jobs at the time the server 300 receives the print jobs are listed. Further, a list 620 shown in FIG. 9 is also part of the data in the foregoing management information 351. If receiving the print jobs from the PCs 200A-200C, the server 300 registers the jobs received this time on the list 620. All data of a document name, setting parameters and printable MFPs is registered in an associated manner in the server 300. The document name is composed of an ID of a user who inputs a job, a PC name, date (June 16th in the present embodiment), a sequence number within the current date and a file name of print object data in order. The setting parameter is the content set using the printing setting screen 500 in FIG. 8. Further, “WM” of the setting parameter means the watermark. The printable MFP is a MFP name derived according the user ID and the setting parameter and the restriction information shown in FIG. 6.

Next, a series of operations until a printed matter is actually obtained from the input of print jobs are described with reference to display screens in FIG. 10-FIG. 12. Herein, it is described that a user A of which the ID is U00001 inputs the jobs.

The user A inputs print jobs with any one of the PCs 200A-200C, and moves to any MFP. Herein, the user moves to the MFP 100C (MFP_C). If the user A completes the login authentication on the MFP 100C, the MFP 100C displays a screen 701 shown in FIG. 10. The list displayed herein is a list of the print jobs input by the user A, and lists of print jobs input by other users are not displayed. The user A designates a desired document by touch press to select a print job. In the present embodiment, “AAAA.doc” is selected.

The “AAAA.doc” is the setting of the full color printing according to FIG. 9, and cannot be printed by the MFP 100C that cannot carry out the full color printing. Therefore, the MFP 100C displays a screen 710 shown in FIG. 11. The MFP 100C displays a message indicating that the document cannot be printed and a list 712 serving as a list of MFPs capable of executing the print job on the screen 710. The user A can designate a MFP for printing in the list 712. Further, in a case in which the setting location of the MFP is not known only by the identification information of the list 712, the user A presses the button 711.

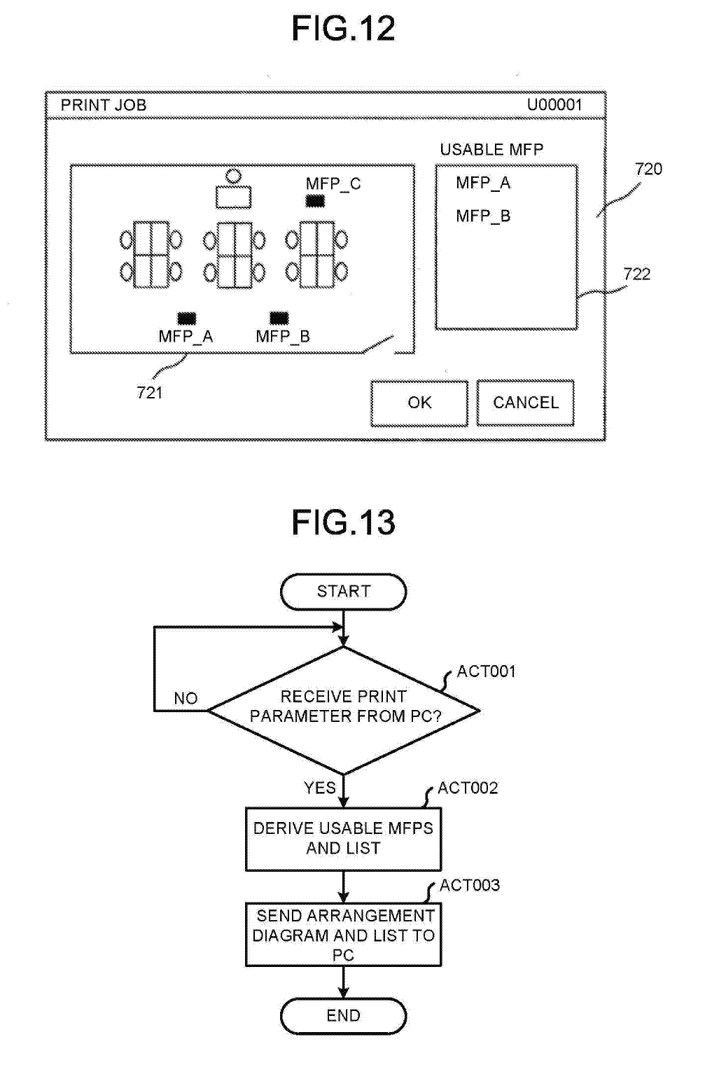

FIG. 12 illustrates a screen image displayed by the MFP 100C after the button 711 in FIG. 11 is pressed. An arrangement diagram 721 (image 611 in FIG. 7 (B)) registered in the server 300 and a list 722 of printable MFPs are displayed in the screen 720. The user A selects an MFP from the list 722, confirms the arrangement diagram 721 to specify the location of the selected MFP, and moves to the MFP. After the user A carries out the login authentication on the MFP serving as the movement destination, the MFP immediately starts the printing of the “AAAA.doc”.

Hereinafter, an example of operations of the printing system 1 is described with reference to a flowchart. FIG. 13 illustrates an example of operations of the server 300 at the time of displaying the screen 510 shown at the lower stage in FIG. 8. Further, the processor 301 of the server 300 executes the program 351 stored in the HDD 304 to carryout the operations in the flowchart shown in FIG. 13.

The processor 301 determines whether to receive print parameters from the PCs 200A-200C via the network I/F 307 (ACT 001). If the button 502 in FIG. 8 is pressed on any one of the PCs 200A-200C (on the PC 200A in the present embodiment), the PC 200A sends a parameter set by the parameter setting column 501 to the server 300. Whether the parameter is received is determined in the processing in ACT 001. If the setting parameter is received (Yes in ACT 001), the processor 301 derives MFPs that can carry out the printing and lists the MFPs on the basis of the received setting parameters and the restriction information shown in each of FIG. 6 (A) and FIG. 6 (B) (ACT 002). The processor 301 controls the network I/F 307 to send the arrangement diagram and the created list to the PC 200A (ACT 003). The PC 200A receiving the arrangement diagram and the created list displays the screen 510 shown at the lower stage in FIG. 8. After ACT 003, the processing is ended and becomes the waiting operation in ACT 001.

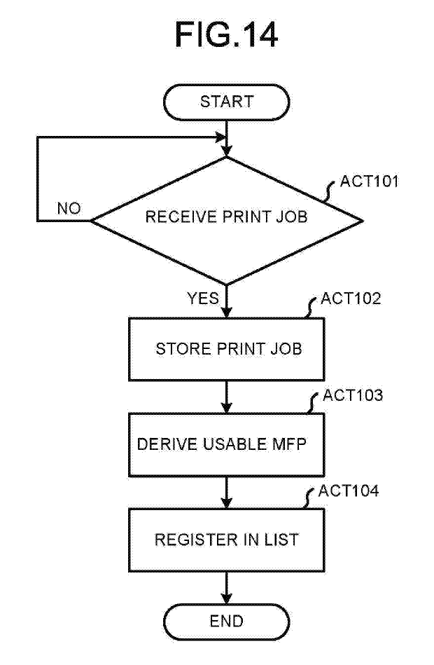

FIG. 14 is a diagram illustrating an example of operations of the server 300 at the time of receiving the print jobs from the PCs 200A-200C. The processor 301 of the server 300 waits for the print jobs (ACT 101). If the print jobs are received from the PCs 200A-200C (Yes in ACT 101), the processor 301 stores the received print jobs in the HDD 304 or the DRAM 302 (ACT 102).

The processor 301 derives one or a plurality of usable MFPs on the basis of the setting parameters in the print jobs and the restriction information shown in FIG. 6 (A) and FIG. 6 (B) (ACT 103). Further, the user ID is included in one of the setting parameters in the print jobs, and the processor 301 also takes the restriction by the user into consideration to derive the usable MFP according to the user ID and the correspondence relationship in FIG. 6 (A).

Further, the processor 301 combines the data to create the document name shown in FIG. 9 and sets the created document name, the setting parameter, the printable MFP as one record to register the record in the list 620 (ACT 104). After ACT 104, the operations shown in FIG. 14 are ended, and the processing returns to the waiting operation in ACT 101.

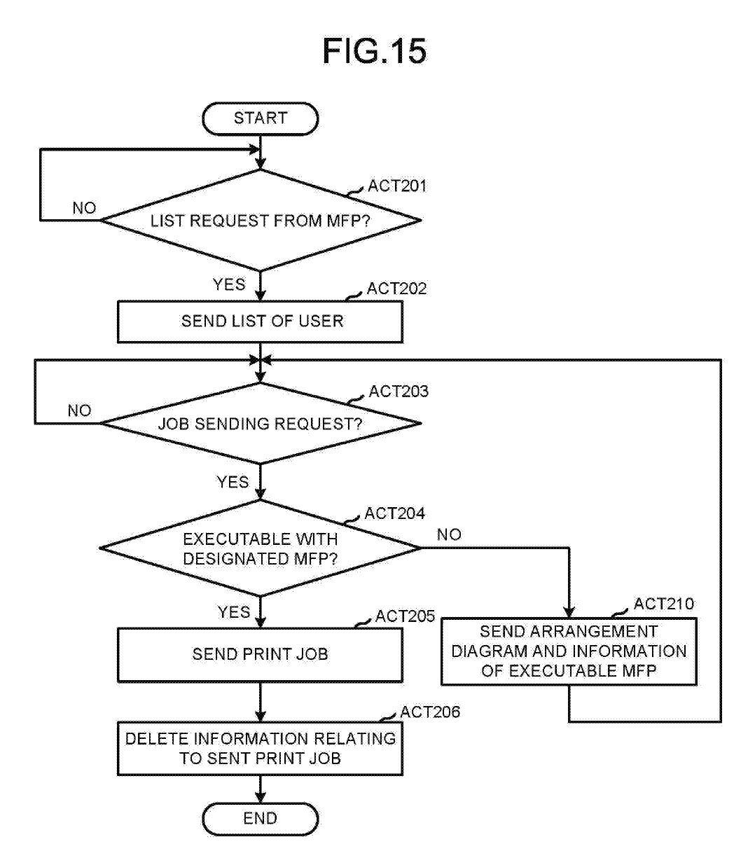

FIG. 15 is a flowchart illustrating an example of operations of the server 300 after the user moves to the MFPs 100A-100C and completes the login authentication. The processor 301 of the server 300 determines whether to receive a telegram of the sending request of the list from an MFP (ACT 201). The received list request telegram includes the identification information of the MFP serving as the telegram sending source and the ID of the authenticated user who is using the MFP at present. Further, herein, it is described that the MFP 100C is operated by the user and the MFP 100C sends the list request telegram.

If receiving the list request telegram from the MFP 100C (Yes in ACT 201), the processor 301 extracts the job of the user from the list 620 shown in FIG. 9 and sends the list of the extracted record to the MFP 100C (ACT 202). In this way, the MFP 100C displays the screen 701 exemplified in FIG. 10.

The processor 301 waits for a telegram of the job sending request from the MFP 100C (ACT 203). The job sending request telegram includes the identification information of the print job and information (referred to as sending destination MFP information) for designating which MFP the job is sent to. Further, as described later, the designated sending destination MFP is not limited to the MFP (herein, the MFP 100C) serving as the sending source of the job sending request telegram.

If receiving the job sending request telegram (Yes in ACT 203), the processor 301 determines whether or not the print job can be printed by the MFP designated as the sending destination with reference to the list 620 shown in FIG. 9 (ACT 204). In a case in which, for example, the MFP 100C is set as the sending destination and the request telegram for sending the print job of the “AAAA.doc” shown in FIG. 9 is received, No is taken in ACT 204 on the basis of the correspondence relationship in FIG. 9. This is because the MFP 100C cannot carry out the color printing. On the other hand, in a case in which, for example, the MFP 100A is set as the sending destination and the request telegram for sending the print job of the “AAAA.doc” shown in FIG. 9 is received, Yes is taken in ACT 204 on the basis of the correspondence relationship in FIG. 9.

If the Yes is taken in ACT 204 (Yes in ACT 204), the processor 301 sends the print job that receives the request to the MFP designated by the sending destination (ACT 206). After that, if a job completion notification is received from the MFP, the processor 301 deletes information (job data, entry of the list and the like) relating to the sent print job (ACT 206). After ACT 206, the processing in FIG. 15 is ended and returns to the waiting operation in ACT 201.

If the No is taken in ACT 204 (No in ACT 204), the processor 301 extracts the list of the usable MFPs from FIG. 9, and sends the list together with the arrangement diagram to the MFP 100C serving as the sending source (ACT 210). Then, the processing returns to ACT 203. The MFP 100C receiving each data in ACT 210 displays each of the screens 710 and 720 shown in FIG. 11 and FIG. 12.

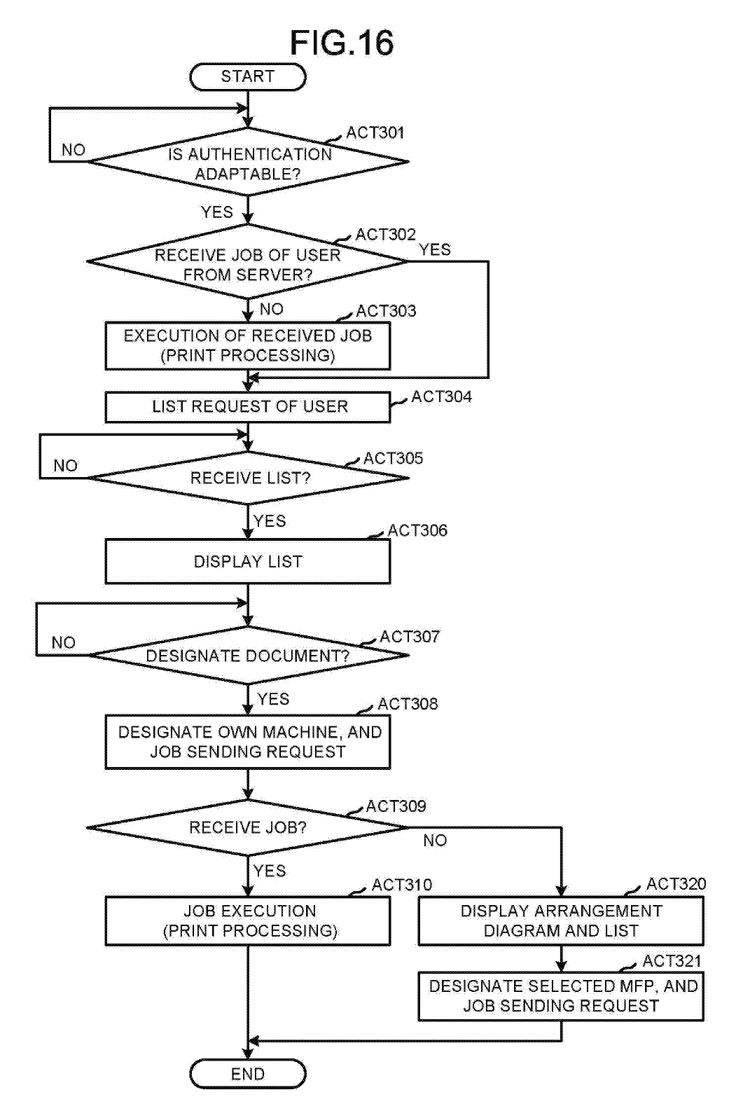

FIG. 16 is a flowchart illustrating an example of operations of the MFPs 100A-100C. The user moves to any one of the MFPs 100A-100C to hold his/her IC card over the card reader 221. The control section 110 determines whether or not the authentication processing based on the information in the IC card in the authentication section 220 is adaptable (ACT 301). If the authentication is adaptable (Yes in ACT 301), the control section 110 determines whether or not there is a print job of a user (hereinafter, a login user) who is logged in which is received from the server 300 (ACT 302). If there is the received job (Yes in ACT 302), the control section 110 executes the received print job (ACT 303). If there is no received job (No in ACT 302), the processing in ACT 303 is skipped. The meanings of the execution of the processing in ACT 302 and ACT 303 are described later.

The control section 110 sends a telegram for requesting the print job list of the login user to the server 300 (ACT 304), and waits for until the list is received (loop of No in ACT 305). If the list is received from the server 300 (Yes in ACT 306, and also refer to ACT 202), the list is displayed as exemplified in FIG. 10 (ACT 306).

If the login user selects a document from the list (Yes in ACT 307), the control section 110 designates own machine as the sending destination and sends the sending request telegram of the selected job to the server 300 (ACT 308). If the print job is received from the server 300 (Yes in ACT 309, and also refer to ACT 205 in FIG. 15), the control section 110 executes the print job (ACT 310). Furthermore, the job received in the processing in ACT 309 is a job which can be carried out by the corresponding MFP according to the determination in ACT 204 in FIG. 15.

On the other hand, if the print job is not received, in other words, if the arrangement diagram and the list of the printable MFPs are received (No in ACT 309, and also refer to ACT 210), the control section 110 controls to display the arrangement diagram and the list on the operation panel 104 (ACT 320). In this way, each of the screens in FIG. 11 and FIG. 12 is displayed on the operation panel 104.

If a MFP is designated from the list in each of the screens in FIG. 11 and FIG. 12 by the user, the control section 110 designates the MFP as the MFP serving as the sending destination, and sends the telegram of the job sending request to the server 300 (ACT 321).

A case in which the print job of the“AAAA.doc” is executed by the MFP 100C is an example, and the operations after the processing in ACT 308 are supplementary explanation. In the processing in ACT 308, the MFP 100C serving as own machine is set as the sending destination, the server 300 is requested to send the print job of the“AAAA.doc”. The server 300 receiving the request determines whether or not the job of the“AAAA.doc” can be carried out by the MFP 100C in the processing in ACT 204 in FIG. 15. If it is assumed that the print job of the“AAAA.doc” can be carried out by the MFP 100C, the print job is sent (ACT 205 in FIG. 15), and the printing is carried out by the MFP 100C (ACT 310). If the print job of the“AAAA.doc” cannot be carried out by the MFP 100C, the server 300 sends the arrangement diagram and the MFP list to the MFP 100C (ACT 210 in FIG. 15), and the arrangement diagram and the MFP list are displayed by the MFP 100C (ACT 320, FIG. 11 and FIG. 12). The server 300 that executes the processing in ACT 210 enters the operation for waiting for a next job sending request (ACT 203 in FIG. 15).

As stated above, in a case in which the “AAAA.doc” cannot be carried out by the MFP 100C, the MFP 100C displays the arrangement diagram and the MFP list. In the processing in ACT 321, if the user selects, for example, the MFP 100A, the server 300 is requested to send the print job of the“AAAA.doc” to the selected MFP 100A.

The server 300 which is in a state of waiting for the job sending request receives the request. According to the correspondence relationship in FIG. 9, since the MFP 100A can carry out the printing of the “AAAA.doc”, the Yes is taken in ACT 204. In this way, the server 300 sends the print job of the“AAAA.doc” to the MFP 100A. The MFP 100A receives the print job.

The user moves to the MFP 100A to carry out the login authentication on the MFP 100A (ACT 301) while carrying out transmission and reception of the print job of the “AAAA.doc”. If the authentication is adaptable (ACT 301), the MFP 100A carries out the printing of the “AAAA.doc” immediately (Yes in ACT 302, and ACT 303). In the present embodiment, the print job is started without receiving the instruction and the operation from the user such as the job selection and the print execution instruction.

In this manner, while the user moves from the MFP 100C to the MFP 100A to carryout the login authentication, the MFP 100A receives the job to be printed. Therefore, after the login authentication, the printed matter of the “AAAA.doc” can be obtained immediately.

In the above, a form in which the server 300 receives the jobs in a centralized manner and deliveries the jobs to the MFPs; however, the same functions as the server 300 may be included in one of the MFPs. In this way, the server 300 is removed from the system, and the MFP receives the jobs in a centralized manner and deliveries the jobs to other MFPs.

Further, in the present embodiment, it is described that the arrangement diagram indicating the setting locations of the MFPs is displayed; however, in addition to the arrangement diagram (drawing), a document described to an extent guidable to the MFPs may be displayed.

In the present embodiment, a case in which a function for carrying out the invention is recorded inside the apparatus in advance is described; however, the invention is not limited to this; the same function may be downloaded from a network to the apparatus, or a unit for storing the same function in a recording medium may be installed in the apparatus. The form of the recording medium is not limited as long as it is a recording medium capable of storing a program such as a CD-ROM and being read by the apparatus. Further, the function obtained by being installed or downloaded in advance in this manner may be realized in cooperation with an OS (operating system) inside the apparatus.

As stated above in detail, according to the technology described in this description, it is possible to switch the delivery destination so that it becomes a print job for the image forming apparatus which can execute the print job from the image forming apparatus which cannot execute the print job. Further, it is possible to reduce waiting time of execution of the print job in the image forming apparatus serving as the switched destination.

The present invention can be embodied in a variety of other forms without departing from the spirit or main characteristics. Therefore, the above-mentioned embodiments are presented by way of example only in all respects, and should not be interpreted restrictively. The scope of the present invention is indicated by the scope of claims and is not bound at all in the description text. Furthermore, all modifications, various improvements, substitutions and reforming falling within the equivalent scope of the scope of claims are all within the scope of the present invention.

What is claimed is:

1. A printing system comprising a plurality of image forming apparatuses connected to a network, comprising:
a first image forming apparatus configured to fail to carry out a first print job due to setting parameters of the first print job;
a job sending component configured to send the first print job to another image forming apparatus designated via an operation section of the first image forming apparatus; and
a second image forming apparatus serving as the designated image forming apparatus configured to execute the first print job received from the job sending component without receiving an instruction of job execution via its own operation section.

2. The printing system according to claim 1, wherein
the first image forming apparatus displays a list of other image forming apparatuses that can execute the first print job and information indicating setting locations of the other image forming apparatuses on a display section.

3. The printing system according to claim 1, wherein
the second image forming apparatus executes the first print job if a login authentication of a user who instructs the execution of the first print job is completed.

4. The printing system according to claim 1, wherein
identification information of the user who instructs the execution of the first print job is included in the setting parameters of the first print job; and
a job delivery component selects an image forming apparatus that can or cannot execute the first print job from the plurality of the other image forming apparatuses on the basis of the identification information of the user.

5. The printing system according to claim 1, wherein
color material information indicating whether printing with a decolorable color material is carried out is included in the setting parameters of the first print job; and
a job delivery component selects an image forming apparatus that can or cannot execute the first print job from the plurality of the other image forming apparatuses on the basis of the color material information.

6. The printing system according to claim 4, wherein
the job delivery component is a server.

7. The printing system according to claim 5, wherein
the job delivery component is a server.

8. The printing system according to claim 1, further comprising:
a plurality of personal computers.

9. The printing system according to claim 4, further comprising:
a card reader that reads authentication information of the user.

10. A printing system network comprising a plurality of image forming apparatuses and a plurality of personal computers connected to the printing system network, comprising:
a first image forming apparatus configured to fail to carry out a first print job due to setting parameters of the first print job from a first personal computer;
a job sending component configured to send the first print job to another image forming apparatus designated via an operation section of the first image forming apparatus; and
a second image forming apparatus serving as the designated image forming apparatus configured to execute the first print job received from the job sending component without receiving an instruction of job execution via its own operation section.

11. The printing system network according to claim 10, wherein
the first image forming apparatus displays a list of other image forming apparatuses that can execute the first print job and information indicating setting locations of the other image forming apparatuses on a display section.

12. The printing system network according to claim 11, wherein
the second image forming apparatus executes the first print job if a login authentication of a user who instructs the execution of the first print job is completed.

13. The printing system network according to claim 10, wherein
identification information of the user who instructs the execution of the first print job is included in the setting parameters of the first print job; and
a job delivery component selects an image forming apparatus that can or cannot execute the first print job from the plurality of the other image forming apparatuses on the basis of the identification information of the user.

14. The printing system network according to claim 10, wherein
color material information indicating whether printing with a decolorable color material is carried out is included in the setting parameters of the first print job; and
a job delivery component selects an image forming apparatus that can or cannot execute the first print job from the plurality of the other image forming apparatuses on the basis of the color material information.

15. A method of distributing a print job to an image forming apparatus in a network comprising a plurality of image forming apparatuses, comprising:
failing to carry out a first print job by a first image forming apparatus due to setting parameters of the first print job;
sending the first print job to another image forming apparatus designated via an operation section of the first image forming apparatus; and
executing the first print job by a second image forming apparatus serving as the designated image forming apparatus without receiving an instruction of job execution via an operation section of the second image forming apparatus.

16. The method of distributing a print job according to claim 15, further comprising:
displaying on the first image forming apparatus a list of other image forming apparatuses that can execute the first print job and information indicating setting locations of the other image forming apparatuses.

17. The method of distributing a print job according to claim 15, further comprising:
executing the first print job if a login authentication of a user who instructs the execution of the first print job is completed.

18. The method of distributing a print job according to claim 17, further comprising:
including identification information of the user who instructs the execution of the first print job in the setting parameters of the first print job; and
selecting an image forming apparatus that can or cannot execute the first print job from the plurality of the other image forming apparatuses on the basis of the identification information of the user.

19. The method of distributing a print job according to claim 15, further comprising:
including color material information indicating whether printing with a decolorable color material is carried out in the setting parameters of the first print job; and
selecting an image forming apparatus that can or cannot execute the first print job from the plurality of the other image forming apparatuses on the basis of the color material information.

20. The method of distributing a print job according to claim 15, further comprising:
reading authentication information of a user.
